(19) United States
(12) Patent Application Publication
(10) Pub. No.: US 2023/0083215 A1
(43) Pub. Date: Mar. 16, 2023

(54) HARNESSES

(71) Applicant: TREEMAGINEERS LTD, Pitlochry (GB)

(72) Inventors: Christopher COWELL, Pitlochry (GB); Elliot TANNER, Montgomery Powys (GB)

(21) Appl. No.: 17/801,616

(22) PCT Filed: Dec. 10, 2021
(86) PCT No.: PCT/GB2021/053256

§ 371 Date: Aug. 23, 2022

(30) Foreign Application Priority Data
Dec. 11, 2020 (GB) 2019624.2

(51) Int. Cl. A62B 35/00; A63B 29/02

(52) U.S. Cl. CPC A62B 35/0037; A62B 35/0012; A62B 35/0031; A63B 29/02

(57) ABSTRACT

Harnesses and methods of their manufacture are disclosed. The harnesses include a structural sub-assembly for use in construction of a waist band of a harness, the structural assembly including two primary load-bearing elements and a semi-loadbearing flexible substrate sheet, Each primary load-bearing element is formed from elongate, flexible textile webbing that extends, typically in a loop, that passes through multiple apertures in the sheet to form a woven structure with the sheet, Lengths of the two primary load-bearing elements (or one primary load-bearing element and another component of the structure) extend from a center line of the sheet upon one another and form a structure having three or more layers including the sheet The sub-assembly can be constructed by mounting the sheet on a jig and threading webbing components through apertures in the sheet prior to forming stitching to secure the webbing components.

### CROSS-REFERENCE TO RELATED APPLICATIONS

This application is the U.S. national phase of International Application No. PCT/GB2021/053256 filed Dec. 10, 2021, which designated the U.S. and claims priority to GB Patent Application No. 2019624.2 filed Dec. 11, 2020, the entire contents of each of which are hereby incorporated by reference.

### BACKGROUND OF THE INVENTION

### Field of the Invention

The present invention relates to harnesses. Specifically, it relates to harnesses for use by a climber for access and fall arrest, or by a person working at height as a work support.

### Description of the Related Art

A traditional form of construction of a harness includes a waist band in which structural and non-structural components are layered to create a unified component A successful development of this provides a harness that incorporates a waist band that has a structural assembly that is constructed as a combination of elongate primary load bearing elements (typically formed from textile webbing) and a semi-loadbearing flexible substrate sheet. The primary load bearing elements and the substrate sheet are interwoven to create a composite construction that is load bearing and flexible and supportive to the user. The waist band also includes various hardware components to which other components of the harness are connected and padding to provide a comfortable interface between the structural assembly and a user's back. This form of construction can be seen in, for example, EP-A-3 138 608.

While the harness shown in EP-A-3 138 608 has been very successful and performs well, it is difficult to manufacture, requiring the structural textile elements to be woven through the sheet material in a specific order, which is a time-consuming and complex process that is labour intensive and is easy to get wrong. The arrangement of components in the harness also means that multiple sequences of sewing operations are required, few of which can readily be automated, and proper tensioning of webbing components is difficult to achieve.

### SUMMARY OF THE INVENTION

An aim of this invention is to provide a harness that has the benefits of the harness shown in EP-A-3 138 608, but which is easier, and therefore less costly, to manufacture and which provides improvement in comfort and ergonomics.

To this end, from a first aspect, this invention provides a structural assembly for use in construction of a waist band of a harness, the structural assembly comprising two (or more) primary load-bearing elements and a semi-loadbearing flexible substrate sheet, wherein each primary load-bearing element is formed from elongate, flexible textile webbing that extends that passes through multiple apertures in the sheet to form a woven structure with the sheet, wherein lengths of the two primary load-bearing elements extend from a centre line of the sheet upon one another and form a structure having three or more layers including the sheet.

Most typically, at the centre line there is a region in which two primary load-bearing elements are positioned one on top of the other and on the sheet to form a three-layered structure. Note that the three-layered region includes three distinct components (e.g., the sheet and two primary load-bearing elements) and not two parts of the same component overlapping one another.

Either or both of the primary load-bearing elements may be formed as a loop. For example, end portions of the or each load-bearing member are formed as a loop are connected together, for example by stitches.

A structural assembly embodying the invention may further include securing elements, typically of elongate flexible textile webbing, and typically connected to one of the primary load-bearing elements. The securing elements may include releasable buckle components that allow them to be interconnected whereby the structural assembly is formed into a loop. The securing elements may be formed from two lengths of elongate flexible textile webbing connected to the primary load-bearing element at locations spaced from the centre line. Alternatively, the securing elements may be formed from a single length of elongate flexible textile webbing connected to the primary load-bearing element and which extends across the centre line in contact with the primary load-bearing element.

In the region of the centre line, the structural assembly may include a restraint assembly through which one or both of the primary load-bearing elements pass, the restraint assembly having formations to maintain the primary load-bearing elements in position one upon the other. In embodiments described above where the securing elements are formed from a single length of elongate flexible textile webbing, that single length of elongate flexible textile webbing passes through the restraint assembly. The restraint assembly may include an attachment component, such as a metal ring, to which a connector can be applied to secure the structural assembly to an external component. The restraint assembly may further include a base disposed between the attachment component and the substrate sheet Preferably, the base and the attachment component have mutually-engaging surfaces that are shaped to allow the attachment component to pivot on the base. The base may include an upper connection formation and a lower connection formation that are suitable for connection to upper and lower subassemblies (such as leg loops) of a harness. This allows load to be transferred from the upper and lower subassemblies through the base without transfer of the entire load through the structural subassembly.

The structural assembly typically further includes one or more hardware assemblies secured to the substrate sheet by the primary load-bearing elements. For example, the hardware assemblies may include side attachment arrangements (typically, two, symmetrically on a centre line), each of which side attachment includes a load-bearing component secured to the substrate sheet by a primary load-bearing element.

From a second aspect, this invention provides a harness comprising a waist belt, in which the waist belt includes a structural assembly embodying the first aspect of the invention. Securing elements described in the last-preceding paragraph enable the waist belt to be fastened for use around a user's waist. They are preferably adjustable to allow the tension about a user's waist to be adjusted.

A harness embodying this aspect of the invention typically includes two leg loops suitable for surrounding a user's thighs and connected by flexible risers to hardware components of the structural assembly.

A harness that includes a structural assembly comprises a restraint assembly that includes one or more of an attachment component and a base disposed between the attachment component and the substrate sheet, the base and the attachment component having mutually-engaging surfaces that are shaped to allow the attachment component to pivot on the base, in which the base includes an upper connection formation and a lower connection formation, the harness further including an upper-body harness sub-assembly that is connected to the upper connection formation and to a forward attachment point of the harness. In such a harness, the structural assembly may optionally be an embodiment of the first aspect of the invention or may have an alternative construction independent of the first aspect of the invention.

The lower connection formation is connected to each of the leg loops. Typically, the lower connection formation includes two lugs, each lug being connected to a respective leg loop. The upper-body harness sub-assembly includes two tensile members each intended during use to extend over a respective shoulder of a user.

From a third aspect, this invention provides a method of making a structural assembly for use in construction of a waist band of a harness, which structural assembly includes two primary load-bearing elements of elongate, flexible textile webbing and a semi-loadbearing flexible substrate sheet that has multiple apertures through which the primary load-bearing elements can pass and which has a centre line, the method including:
a. locating the primary load-bearing elements one upon the other at or close to the centre line;
b. passing the primary load-bearing elements through a plurality of apertures in the substrate sheet and through hardware elements; and
c. securing end portions of the primary load-bearing elements under tension to the substrate sheet, such that each primary load-bearing element forms a continuous loop that is woven through the substrate sheet.

The primary load-bearing elements are preferably located one upon the other at the centre line by passing them through a restraint assembly. Alternatively or additionally, the primary load-bearing elements may be located one upon the other at the centre line by sewing them onto the substrate sheet.

### BRIEF DESCRIPTION OF THE DRAWINGS

Embodiments of the invention will now be described in detail, by way of example, and with reference to the accompanying drawings, in which:

FIG. 1 is a rear view of the known harness shown in EP-A-3 138 608;

FIG. 2 shows a structural assembly for a waist band of a harness being a first embodiment of the invention;

FIG. 3 shows a substrate sheet component of the structural assembly of FIG. 2;

FIG. 4 shows, in detail, a restraint assembly being part of the assembly of FIG. 2;

FIG. 5 is a cross-section through the assembly of FIG. 2 in the region of the restraint assembly;

FIGS. 6 and 7 are views of the components of the restraint assembly shown in FIG. 4;

FIG. 8 shows upper and lower primary load bearing elements of the structural assembly of FIG. 2 in the components of the restraint assembly in a first step of assembling the structural assembly;

FIG. 9 shows a first step in installation of the upper and lower primary load bearing elements in a substrate sheet of the structural assembly of FIG. 2;

FIGS. 10 to 13 show successive steps of installation of components of side attachment arrangements of the structural assembly of FIG. 2;

FIG. 14 shows the structural assembly of FIG. 2 with upper and lower primary load bearing elements sewn into position;

FIG. 15 shows a central region of a harness assembly that incorporates a variation to a restraint assembly;

FIG. 16 shows a structural assembly for a waist band of a harness being a second embodiment of the invention and that incorporates the central region FIG. 15;

FIG. 17 shows a harness that incorporates a structural assembly of FIG. 16 and an upper-body harness sub-assembly;

FIGS. 18, 19 and 20 show stages of construction of the structural assembly of FIG. 16;

FIG. 21 shows a substrate sheet and a lower primary load-bearing component of a third embodiment of the invention;

FIG. 22 is a detail showing connection between the substrate sheet and the lower primary load-bearing component of the third embodiment of the invention;

FIGS. 23 to 25 show subsequent assembly steps of the third embodiment of the invention.

### DESCRIPTION OF THE PREFERRED EMBODIMENTS

In this specification, components may be said to be “permanently” attached or secured to other components. This is to be understood as meaning permanently throughout their working life, even if such attachment or securing could, in principle, be undone. For example, structural stitching may be considered to be a permanent attachment, because removal and replacement of such stitching would not be considered an acceptable procedure within codes and regulations for safe use of personal protective equipment.

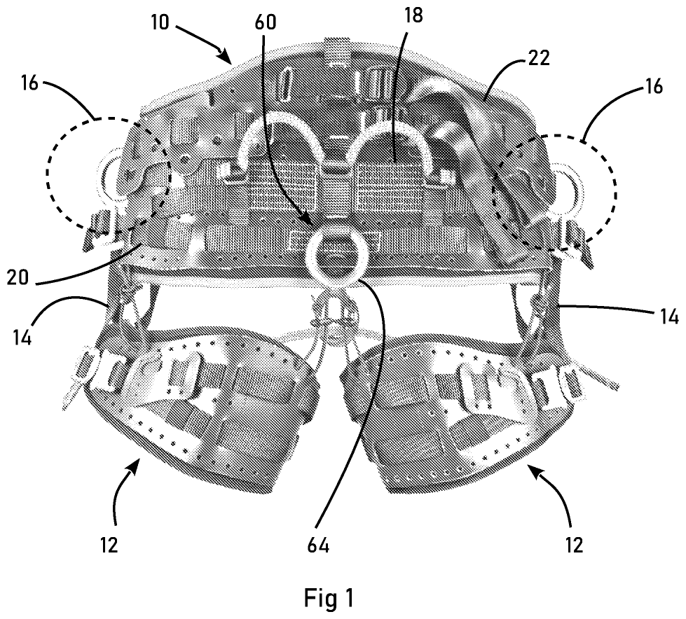

With reference to FIG. 1, a known harness comprises the harness comprises a waist band 10 and two leg loops 12. Each leg loop 12 is connected to the waist band 10 by a respective riser 14 that extends from the leg loop 12 to a respective side attachment arrangement 16 that is secured to the waist band 10. Note that FIG. 1 shows additional components attached to the waist band 10, such as locations to which items of equipment can be secured. When in use, the waist band 10 has a central section which lies against a user's back and wings that extend from the central section around a user's waist.

The waistband 10 of a first embodiment of the invention has a structural assembly that includes upper and lower primary load-bearing elements 18, 20 and a semi-load-bearing substrate sheet 22 is formed from two, high strength, primary load-bearing elements 18, 20 and a substrate sheet 22 that is strong but not intended to be a primary load-bearing component of the harness.

In this example, the primary load-bearing elements 18, 20 are formed from fabric webbing, and the substrate sheet 22 is formed from a PVC/Polyester laminate. Several slots are formed through the substrate sheet 22, through which the primary load-bearing elements 18, 20 can pass from one surface of the substrate sheet 22 to the other, thereby creating a woven composite component. The upper primary load-bearing element 18 carries buckle components (not shown) which can be interconnected to secure the waist band 10 into a continuous loop which, in use, surrounds a user's body.

The method for assembling such a composite structure involves sewing parallel lengths of the primary load-bearing elements 18, 20 across a centre line of the substrate sheet 22 then correctly threading the primary load-bearing elements 18, 20 through the slots in the substrate sheet 22 and through other hardware components before bringing the primary load-bearing elements 18, 20 to the correct tension and sewing their end portions together and to the substrate sheet 22. In this way, the primary load-bearing elements 18, 20 are formed into two separate upper and lower continuous loops of high strength material that extend the length of the waist band.

A central restraint assembly 60 is formed in a subsequent operation by sewing additional webbing to retain a standing ring 64 on the substrate sheet 22 and primary load-bearing elements 18, 20. This assembly method is complex and cannot readily be automated.

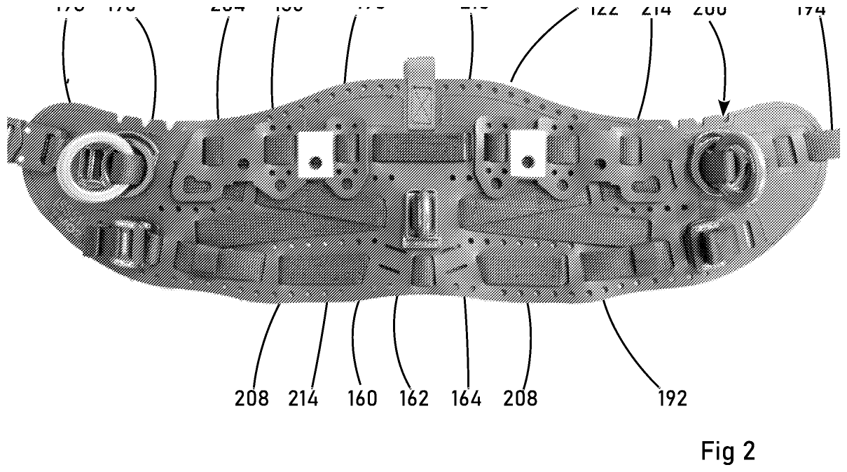

FIG. 2 shows a structural assembly for a waist band of a harness embodying the invention. The components and method of construction of the sub-assembly will become apparent from the following description.

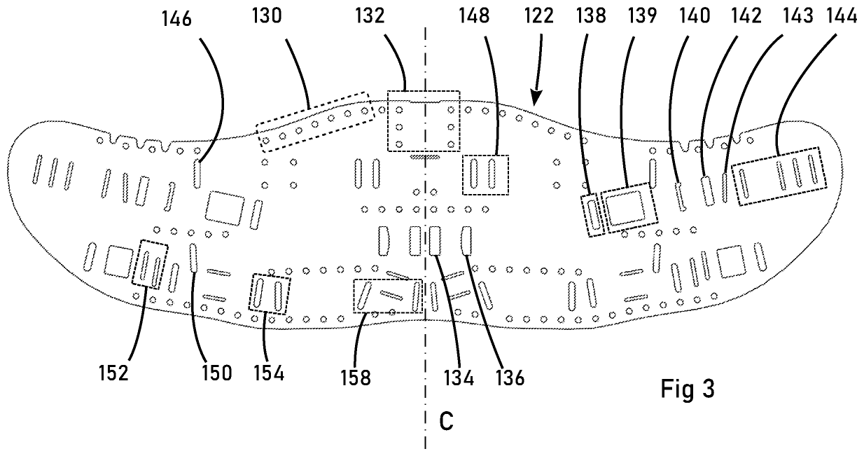

The structural assembly of FIG. 2 is constructed on a 2D PVC/Polyester laminate substrate sheet 122, shown in FIG. 3 upon which several webbing components are arranged. The webbing components are considered to be primary load-bearing elements because it is these components that are principally responsible for transferring the weight of a user of the harness to an external anchor, such as a climbing line. The substrate is considered as being a semi-load-bearing component, in that it has considerable strength, but in general serves a subsidiary role and does not form a part of the main chain of components that transfers the weight of a user of the harness to an external anchor. In particular, the substrate serves to maintain the webbing components in position and to transfer and distribute load between the webbing components and a user of the harness.

FIG. 2 shows an outer surface of the sheet 122; the opposite surface is an inner surface, which is adjacent to a user's body while the harness is in use. The sheet has multiple apertures formed through it, as will be described. The sheet 122 is symmetrical (or approximately so) about a centre line C, so it should be assumed that the description of an aperture or apertures implies that similar apertures are present on the opposite side of the centre line C. The apertures relevant to this invention will now be identified (other apertures shown in FIG. 3 have functions that do not relate directly to this invention). These are as follows:
130, 132: mounting apertures. These are multiple 5 mm circular holes (all of the circular apertures shown in FIG. 3) generally spaced on 15 mm or 45 mm centres and are used to mount accessories onto the structural assembly. In addition, these holes can be used to locate the sheet 122 accurately on pins of a jig to facilitate assembly of the structural assembly. Only examples of these holes 130, 132 are indicated by number in FIG. 3;
134: inner restraint assembly webbing slots;
136: outer restraint assembly webbing slots;
138: upper webbing slots;
139: junction point;
140: inner side attachment webbing slots;
142: outer side attachment webbing slots;
143: upper webbing return slot;
144: outer attachment webbing slots;
146: outer upper webbing slots;
148: central upper webbing slots;
150: lower side webbing slots;
152: lower buckle mounting slots;
154: outer lower webbing slots; and
158: inner lower webbing slots.

The structural assembly of FIG. 2 further includes a restraint assembly 160. The restraint assembly 160 comprises a base 162 and a standing ring 164. Both of these components may be machined, unitary castings or forgings of metal. Alternatively, the base may be a polymer component, since it is not a structural component.

The base 162 has a peripheral shape of a rounded rectangle with long and short dimensions. When mounted on the substrate 122, the long dimension of the base 162 is parallel to the centre-line C. The base 162 has a contact surface 166 that is smooth and slightly concave and extends to the periphery of the base 162. Opposite the contact surface 166, the base 162 has an upstanding flange 168 that extends around the base 162 close to the periphery in a direction approximately perpendicular to the contact surface 166.

A well 172 is defined within the flange 168. The base has a cross-section that is V-shaped, with a rounded apex, in a direction parallel to the short dimension. Two rectangular webbing slots 174 pass from within the well 172 to open at the contact surface 166, the webbing slots 174 extending parallel to the long dimension of the base 162. A bar 176 is formed between the webbing slots 174. The bar 176 has a concave cross section and forms the apex of the V-shape cross-section of the well 172.

When installed on the structural assembly, the restraint assembly 160 is symmetrical about the centre line C, with the long dimension parallel to the centre-line C and the bar 176 being disposed upon or close to the centre-line C.

The standing ring 164 is a generally flat component that has a D-shaped periphery which has a straight side opposite ends of which are connected by a convex outer section. The straight side extends within a plane of symmetry of the standing ring 164. The length of the straight side is approximately the same as the inner dimension of the well 172 along the long dimension. Along the straight side, the outer surface of the standing ring 164 has a convex cross-section at 178 that has a radius that is similar to that of the concave section of the bar 176 such that the standing ring 164 can pivot on the bar 176.

Two apertures, which will be referred to as the webbing aperture 180 and the attachment aperture 182 extend through the standing ring 164. The webbing aperture 180 is elongate and has a straight side parallel to the straight side of the standing ring 164. The attachment aperture 182 is approximately oval in shape and adjacent to the webbing aperture 180. A connector can be secured to the standing ring 164 by passing it through the attachment 182 aperture whereby the standing ring 164 can function as an attachment component for the structural assembly.

The structural assembly further includes upper and lower primary load bearing elements 190, 192 which are formed, in this embodiment, from lengths of flexible textile webbing. Two securing elements 194, each being a length of flexible textile webbing, are stitched to the upper primary load bearing element 190.

A method of construction of the structural assembly will now be described. Construction can be carried out with the substrate sheet 122 mounted on an assembly frame. The assembly frame has locating pins approximately 5 mm in diameter that are passed through mounting apertures 130, 132 in order that the substrate sheet 122 is accurately and predicable positioned. This allows automation to be introduced into the construction procedure, for example by forming at least some of the stitching automatically using CNC tooling.

In assembling the structural assembly, the upper and lower primary load bearing elements 190, 192 are passed through a first one of the webbing slots 174 of the base 162 of the restraint assembly 160, then through the webbing aperture 180 of the standing ring 164, and then through the second of the webbing slots 174 of the base 162. Subsequent tensioning of the upper and lower primary load bearing elements 190, 192 causes the straight side of the standing ring 164 to be pulled into contact with the bar 176 which urges the contact surface 166 of the base 162 onto the sheet 122. Proximity of the webbing slots 174 to the webbing the restraint assembly webbing slots 134 substantially prevent movement of the base 162 on the sheet 122.

From the base 162 of the restraint assembly 160, the upper and lower primary load bearing elements 190, 192 pass through the restraint assembly webbing slots 134 to the inner surface of the sheet 122. The upper and lower primary load bearing elements 190, 192 then extend symmetrically away from the centre line C to outer restraint assembly webbing slots 136, through which the primary load bearing elements 190, 192 pass to the outer surface of the sheet 122.

From the outer restraint assembly webbing slots 136, the upper primary load bearing element 190 extends away from the centre line C to pass through the upper webbing slot 138 to the inner surface of the sheet. The securing element 194 then passes back through the junction point 139 to the outer surface while the upper load bearing element 190 remains at the inner surface. The securing element 194 passes back through the inner side attachment webbing slots 140 to re-join the upper load bearing element 190 at the inner surface. Both the upper primary load bearing element 190 and the securing elements 194 return to the outer surface through the outer side attachment webbing slots 142. The upper load bearing element 190 passes to the inner surface through the upper webbing return slot 143 before turning back towards the centre line C.

Components of side attachment arrangements 200 for the harness are placed in position during installation of the load bearing element 190 and the securing element 194 as described above.

This requires the upper primary load bearing element 190 and the securing elements 194 to pass through a lying ring component 196 and a standing ring component 198 of each side attachment arrangement 200 before the upper load bearing element 190 passes to the inner surface through the upper webbing return slot 143. The standing ring component 198 is a high-strength anchorage through which loading may be transferred from the structural assembly into an anchorage for working support or positioning. The lying ring component 196 provides a connection for risers connected to leg loops through forward connection arrangements of a harness. The lying ring component 196 and standing ring component may be embodiments of the invention disclosed and claimed in UK Patent No. 2 585 889 of the present applicant, the contents of which are incorporated herein by reference.

Outwardly of the side attachment arrangement 200, the securing elements 194 extend away from the centre line C, being woven through outer attachment webbing slots 144. The upper primary load bearing element 190 does not follow the securing elements 194, but instead are folded back towards the centre line C adjacent to the inner surface of the sheet 122 and then threaded through outer upper webbing slots 146 to pass to the outer surface of the sheet 122.

Each of the securing elements 194 carries a buckle component (not shown). The buckle components can be releasably interconnected to enable the waist band to be secured into a continuous loop surrounding the waist of a user.

End portions of the upper primary load bearing element 190 approach one another towards the centre line C, where they are woven through two pairs of central upper webbing slots 148 adjacent to the centre line C. In this embodiment, gear carriers 204 are carried on the upper primary load bearing element 190 between the central upper webbing slots 148 and the outer upper webbing slots 146—the gear carriers 204 have slots through which the upper primary load bearing element 190 is woven.

The lower primary load bearing element 192 extends from the restraint assembly 160 symmetrically away from the centre line C to pass through a lower side webbing slots 150 to the inner surface of the sheet 122. From there, it returns towards the centre line C, passing first through a pair of lower buckle mounting slots 152, between which a bight is formed. The bight retains a metal buckle component 206 against the sheet 122. Between the lower buckle mounting slots 152 and the centre line C, the lower primary load bearing element 192 is woven through the sheet 122 twice: at outer lower webbing slots 154 and then at inner lower webbing slots 158, such that the lower primary load bearing element 192 is on the outer surface of the sheet 122 where it crosses the centre line C.

The end portions of the lower primary load bearing element 192 are then pulled to tension the lower primary load bearing element 192 and are then sewn together to form a continuous loop and sewn down onto the sheet 122 at regions indicated at 208 in FIG. 2. Likewise, end portions of the upper primary load bearing element 190 are then pulled to tension the upper primary load bearing element 190 and are then sewn together to form a continuous loop and sewn down onto the sheet 122, in the region indicated at 210 in FIG. 2. The upper and lower primary load supporting elements 190, 192 may also be sewn together and down onto the sheet 122 in regions indicated at 214 adjacent to the restraint assembly 160. The resulting structural assembly is shown in FIG. 14.

It will be understood that no sewing operation is required to be performed on the sheet 122 prior to the steps described in the last-preceding paragraph, which means that nothing has been done which is difficult to undo. The securing elements 194 are sewn onto the upper primary load bearing element 190; not to the sheet 122. Prior to any sewing being carried out on the sheet 122, the primary load bearing elements 190, 192 and associated hardware 160, 200 should have already been installed into their final positions. Should inspection reveal that any component has been incorrectly installed or positioned, it is a simple matter to reverse the assembly steps that have been carried out so far to rectify the assembly.

Items such as metal loops for carrying items of equipment, and other accessories can be added to the structural assembly in an assembly step after all sewing is completed, and even after the harness has been brought into use. Example of such accessories are disclosed in WO2020/174221. These are secured to the structural assembly by fasteners that are passed through the mounting holes 130, which are distributed across the sheet 122. Over most of the sheet 122, the mounting holes are spaced apart at a constant pitch (15 mm in this example), which allows any accessory with fasteners spaced at that constant pitch to be mounted in a large variety of positions on the sheet 122.

In addition, several mounting holes shown at 132 are disposed in pairs symmetrically on opposite sides of the centre line C. The mounting holes of each pair are spaced by an integer multiple of the constant pitch of the other mounting holes—in this example, they are spaced by 45 mm. This effectively reserves the region around the centre line of the sheet 122 for mounting specific accessories that have their fasteners spaced apart at the increased spacing of the hole pairs at 132.

Much of the advantage of the invention can be obtained without the use of a restraint assembly 160. Lengths of the primary load bearing elements 190, 192 extending from their midpoints are connected to the sheet 122 about the centre line C, typically by sewing them into position. Subsequent steps to complete the structural assembly then proceed as described above.

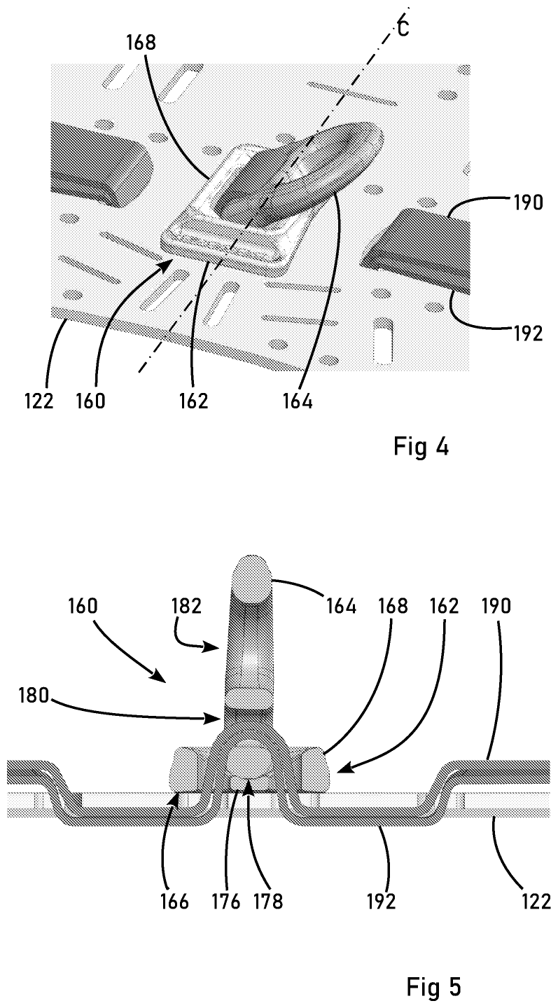

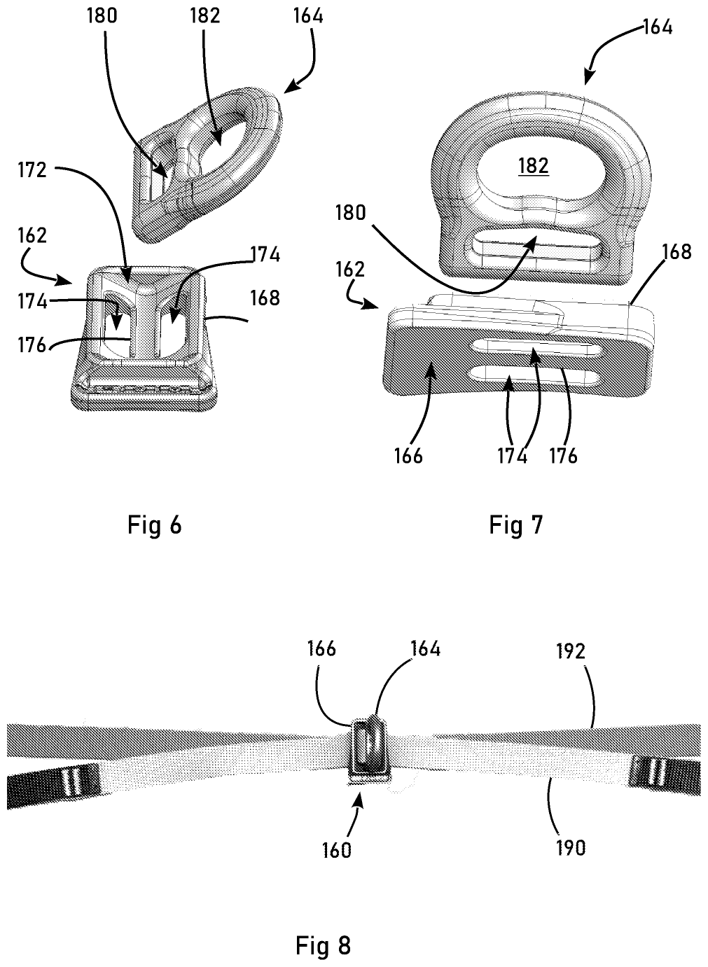

In the assembled harness, the restraint assembly 160 can be required for load-bearing purposes. The restraint assembly 160 can transfer load into the structural assembly. In this embodiment, the primary load bearing elements 190, 192 use the restraint assembly 160 as a common loading point and it is within the restraint assembly that webbing of the primary load bearing elements 190, 192 extend over one another. The contact surface 166 of the base 162 of the restraint assembly 160 spreads load from the standing ring 164 into the sheet 122. As shown in FIG. 4, the standing ring 164 can pivot on the bar 176 about an axis parallel to the centre line C towards the direction of a load applied to it without applying a bending load to the sheet 122. The movement of the standing ring 164 is separated from the sheet 122 by the base 162 thereby minimising wear to the sheet 122.

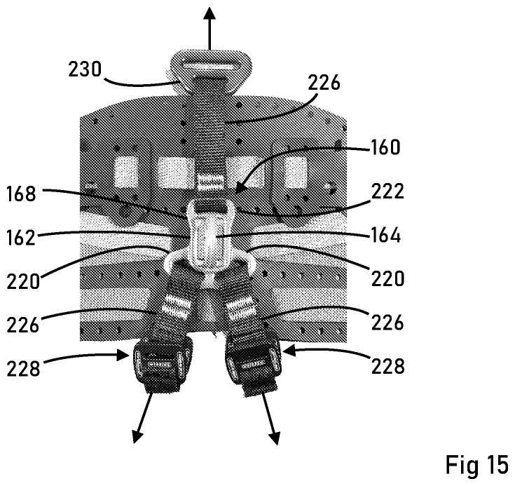

Within the flange 168, the shape and configuration of the base 162 is constrained by its need to cooperate with the standing ring, but the periphery of the base can be varied significantly to provide additional functionality. As an example, the arrangement shown in FIG. 15 provides a base that includes additional loading points. The base includes a pair of lugs 220 to each of which a leg loop connecting assembly 228 is attached and an upper harness connection loop 222 to which a vertical link webbing assembly 227 is attached. Each leg loop connecting assembly 226 comprises a length of webbing that passes through one of the lugs 220 and a connecting buckle 228 and is secured into a loop by structural stitching, so permanently securing the webbing to the base 162 and connecting buckle 228. Each connecting buckle 228 can be connected to a leg loop of the harness. The vertical link webbing assembly 227 comprises a length of webbing that passes through the upper harness connection loop 230 and through a metal connecting link 230 and is secured into a loop by structural stitching, so permanently securing the webbing to the base 162 and connecting link 230. The connecting link 230 of the vertical link webbing assembly 227 can be connected to a webbing component of an upper-body harness assembly, the upper-body harness assembly being further connected to a front part of the harness.

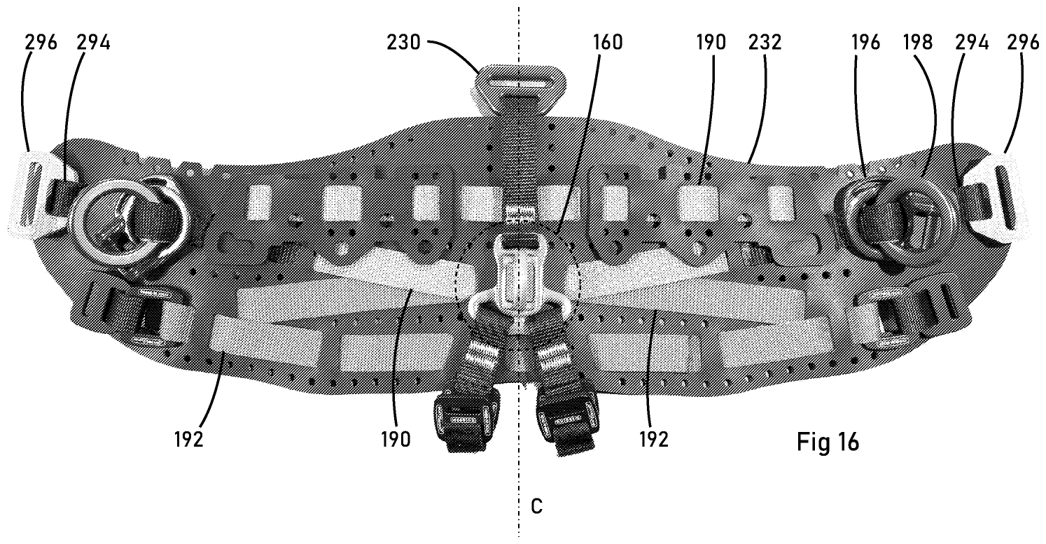

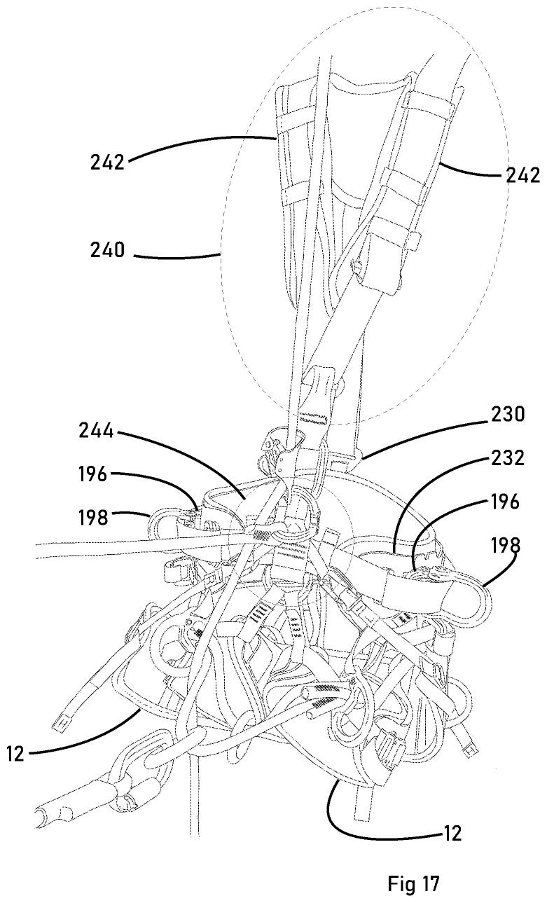

This arrangement might find application in the construction of a work support and fall arrest harness suited for use by a climber working at height, a structural assembly of which is shown in FIG. 16. This embodiment is similar to the first embodiment, with the restraint assembly of FIG. 15, and with differences that will be discussed below. Other components of this embodiment correspond to those of the first embodiment and will not be described further.

In this embodiment, the connecting link 230 of the vertical link webbing assembly 227 is connected to a webbing component of an upper-body harness assembly 240 in the direction indicated by arrows in FIG. 15. The body 162 provides an interconnection that can transfer force between the upper-body harness assembly 240 and the leg loops without that force passing through other components of the structural assembly. The upper-body harness assembly 240 includes two shoulder members 242, which are tensile members that, in use, pass over a user's shoulders. At the front of a harness, the upper-body harness assembly 240 is connected to a ventral connection 244 that transfers load into the waist belt and foreward parts of the leg loops 12.

This embodiment has a structural assembly shown in FIG. 16, constructed on a 2D PVC/Polyester laminate substrate sheet 232, that is similar to that of FIG. 3, with minor detail differences to accommodate components of the harness altered in the second embodiment as compared with the first.

In the second embodiment, each of the securing elements is constituted by a length of webbing 294, referred to as “attachment webbing”, that has a bight formed by structural stitching at one end. The bight passes through a respective buckle component 296 to secure the buckle component 296 permanently to the attachment webbing 294, and the attachment webbing 294 extends from the bight to a free end.

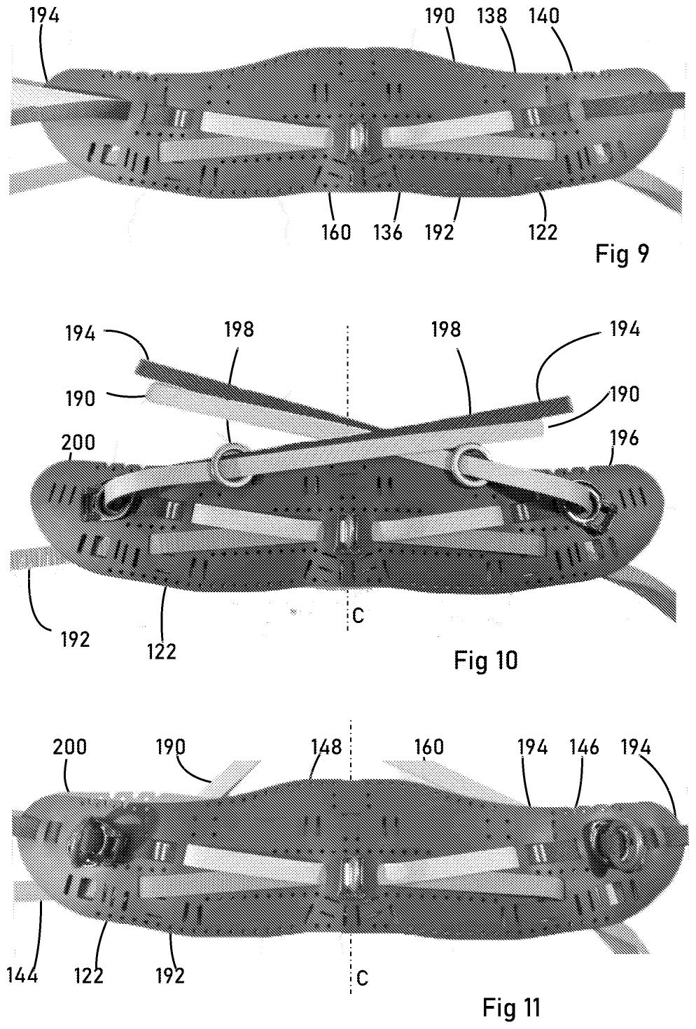

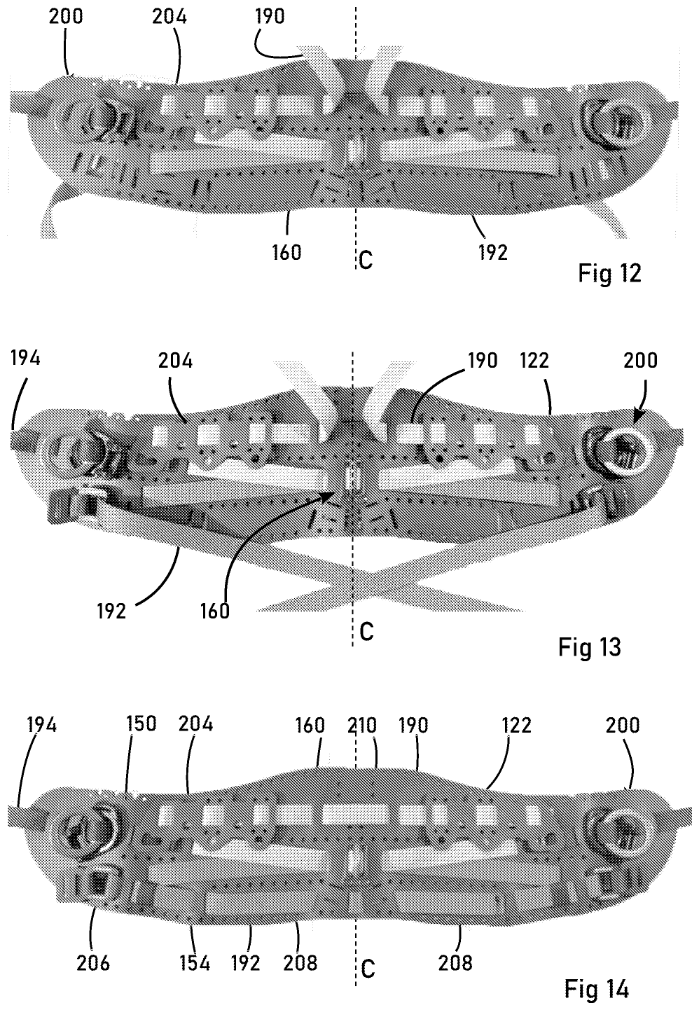

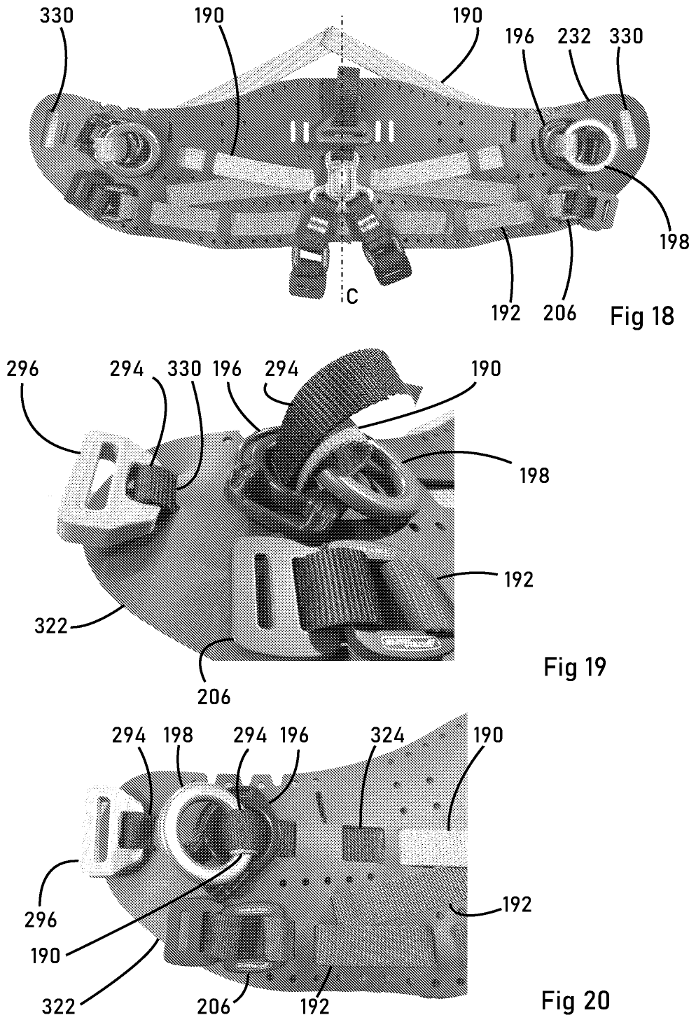

Construction of this embodiment proceeds in much the same manner as the first embodiment up to the stage shown in FIG. 10, but without the presence of the securing elements 194. This stage is shown in FIG. 18.

The free end of the attachment webbing 294 is then passed from the front to the back of the sheet 232 through an attachment webbing slot 330 in the sheet 232. The attachment webbing 294 then again passes through to the front of the sheet 232 to form a bight that passes twice through the lying ring 196 and through the standing ring 198. In the region of the bight, the attachment webbing 294 lies against the upper primary load-bearing member 190. This is shown in FIGS. 19 and 20.

The attachment webbing 294 then continues towards the centre line C of the sheet 232 in alignment with the upper primary load-bearing member 190 and between the upper primary load-bearing member 190 and the back of the sheet 232. The attachment webbing 294 is sewn to the upper primary load-bearing member 190 with structural stitching, a cut-out 324 being formed through the sheet 232 to enable the sewing operation to be performed with the upper primary load-bearing member 190 and the attachment webbing in place on the sheet 232. Optionally, the attachment webbing 294 may be cut to length prior to sewing or it may be manufactured to be the correct length prior to installation.

In a minor variation of the above-described first embodiment, the securing elements 194 are not two separate lengths of webbing, but a single length of securing webbing that carries a buckle element close to each of its ends. The securing webbing is passed through the restraint assembly with the upper and lower primary load bearing elements 190, 192. The securing webbing is subsequently secured by sewing to the upper load bearing elements 190 at intervals.

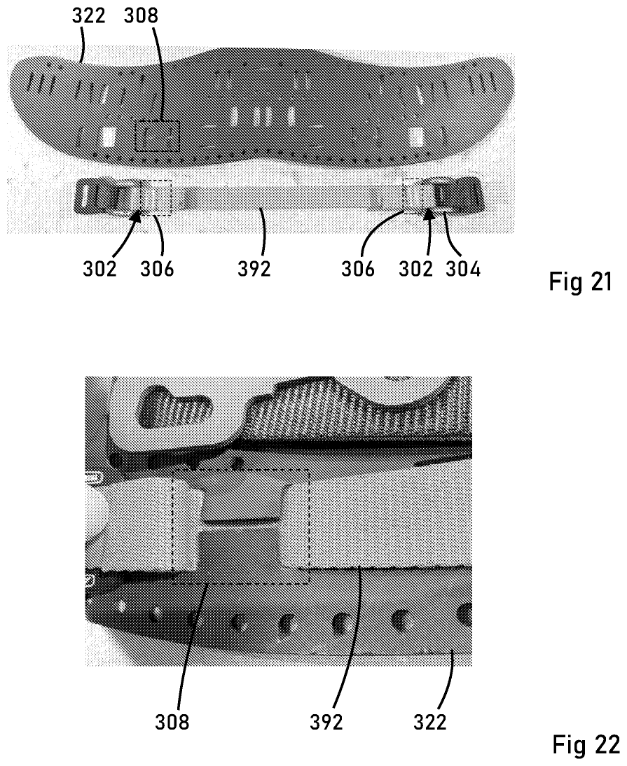

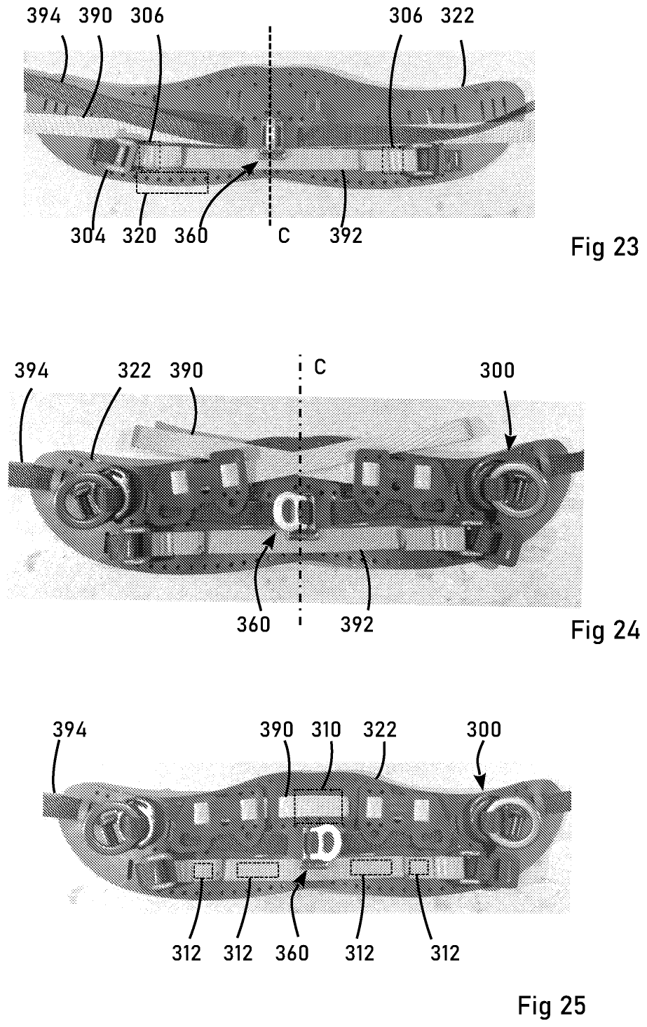

A further alternative arrangement of a structural assembly for a harness is shown in FIGS. 21 to 25. This embodiment may be suitable for use in constructing a harness of smaller size than in the first embodiment. This embodiment is constructed on a substrate sheet 322 similar to that of the first embodiment, but with a different shape and arrangement of openings. As with the first embodiment, the sheet 322 has multiple mounting holes 320.

The securing elements are formed at opposite end portions of a single length of securing webbing 392 that carries a buckle element 304 close to each of its ends. The securing webbing 394 is passed through the restraint assembly 360 with the upper primary load bearing element 390. The securing webbing 394 and the primary load-bearing element 390 extend together from the restraint assembly 360 to the side attachment arrangements 300, weaving through slots in the sheet.

From the side attachment arrangements 300, the securing webbing 394 extends away from the centre line C. The upper primary load bearing element 390 is folded back towards the centre line, and inner end portions of it are sewn together and to the sheet as shown at 310 to form a complete loop.

In this embodiment, the lower primary load bearing element 392 is part of a lower load bearing sub-assembly that is initially separate from the substrate sheet 322, as shown in FIG. 21. The sub-assembly includes a length of webbing, which has end portions, each of which is folded back over the length of webbing and secured by stitches 306 to be formed into a sewn loop 302 that passes through a metal buckle component 304.

The sheet has lower primary webbing slots 308 through the sheet 322 that are H-shaped, having spaced upright portions that are parallel to the centre line C, interconnected by a transverse portion at right angles to the centre line C. The lower load bearing sub-assembly is installed on the sheet 322 by deflecting the material of the sheet 322 in the region of the lower primary webbing slots 308, such that the webbing passes though the upright portions of the primary webbing slots 308, as shown in FIG. 22. The webbing is then sewn to the sheet 322 at regions indicated at 312 in FIG. 25. These stitches serve to locate the webbing in position on the sheet 322 but typically are not load-bearing components within the linked structural components that transfer the weight of a user of the harness to an external anchor, such as a climbing line.

1. A structural assembly suitable for use in construction of a waist band of a harness, the structural assembly comprising two primary load-bearing elements and a semi-loadbearing flexible substrate sheet, wherein each primary load-bearing element is formed from elongate, flexible textile webbing that extends that passes through multiple apertures in the sheet to form a woven structure with the sheet, wherein lengths of the two primary load-bearing elements extend from a center line of the sheet upon one another and form a structure having three or more layers including the sheet.

2. The structural assembly of claim 1 in which one or both primary load-bearing element is formed as a loop.

3. The structural assembly of claim 2 in which end portions of the or each load-bearing member are formed as a loop are connected together.

4. The structural assembly of claim 1 further including securing elements of elongate flexible textile webbing connected to one of the primary load-bearing elements, which securing elements include releasable buckle components that allow the securing elements to be interconnected whereby the structural assembly is formed into a loop.

5. The structural assembly of claim 4 in which the securing elements are formed from two lengths of elongate flexible textile webbing connected to the primary load-bearing element at locations spaced from the center line.

6. The structural assembly of claim 4 in which the securing elements are formed from a single length of elongate flexible textile webbing connected to the primary load-bearing element and which extends across the center line in contact with the primary load-bearing element.

7. The structural assembly of claim 6 which includes a restraint assembly through which one or both of the primary load-bearing elements pass, the restraint assembly having formations to maintain the primary load-bearing elements in position one upon the other.

8. The structural assembly of claim 7 in which the single length of elongate flexible textile webbing passes through the restraint assembly.

9. The structural assembly of claim 7 in which the restraint assembly includes an attachment component to which a connector can be applied to secure the structural assembly to an external component.

10. The structural assembly of claim 9 in which the restraint assembly further includes a base disposed between the attachment component and the substrate sheet.

11. The structural assembly of claim 10 in which the base and the attachment component have mutually-engaging surfaces that are shaped to allow the attachment component to pivot on the base.

12. The structural assembly of claim 9 in which the base includes an upper connection formation and a lower connection formation that are suitable for connection to upper and lower subassemblies of a harness.

13. The structural assembly of claim 1 which further includes one or more hardware assemblies secured to the substrate sheet by the primary load-bearing elements.

14. The structural assembly of claim 13 in which the hardware assemblies include side attachment arrangements, each of which side attachment includes a load-bearing component secured to the substrate sheet by a primary load-bearing element.

15. A harness comprising a waist belt, in which the waist belt includes the structural assembly of claim 1.

16. The harness of claim 15 in which the waist belt includes padding secured to an inner surface of the substrate sheet to be disposed, in use, between the substrate sheet and a user's body.

17. The harness of claim 15 further including two leg loops suitable for surrounding a user's thighs and connected by flexible risers to hardware components of the structural assembly through forward connection arrangements of the harness.

18. The harness of claim 17 in which the structural assembly comprises a restraint assembly that includes an attachment component and a base disposed between the attachment component and the substrate sheet, the base and the attachment component having mutually-engaging surfaces that are shaped to allow the attachment component to pivot on the base, in which the base includes an upper connection formation and a lower connection formation, the harness further including an upper-body harness sub-assembly that is connected to the upper connection formation and to a forward attachment point of the harness.

19. The harness of claim 18 which the lower connection formation is connected to each of the leg loops.

20. The harness of claim 19 which the lower connection formation includes two lugs, each lug being connected to a respective leg loop.

21. The harness of claim 18 in which the upper-body harness sub-assembly includes two tensile members each intended during use to extend over a respective shoulder of a user.

22. The harness of claim 18 further including one or more accessories connected by fasteners through mounting holes of the sheet.

23. A method of making a structural assembly for use in construction of a waist band of a harness, which structural assembly includes two primary load-bearing elements of elongate, flexible textile webbing and a semi-loadbearing flexible substrate sheet that has multiple apertures through which the primary load-bearing elements can pass and which has a center line, the method including:
a. locating the primary load-bearing elements one upon the other at the center line;
b. passing the primary load-bearing elements through a plurality of apertures in the substrate sheet and through hardware elements; and
c. securing end portions of the primary load-bearing elements under tension to the substrate sheet, such that each primary load-bearing element forms a continuous loop that is woven through the substrate sheet.

24. The method of claim 23 in which the primary load-bearing elements are located one upon the other at the center line by passing the primary load-bearing elements through a restraint assembly.

25. The method of claim 23 in which the primary load-bearing elements are located one upon the other at the center line by sewing the primary load-bearing elements onto the substrate sheet.

26. The method of claim 23 in which the substrate sheet is mounted on an assembly jig, which jig has one or more pins that are passed through mounting holes of the substrate sheet.
